(19) United States
(12) Patent Application Publication
(10) Pub. No.: US 2008/0299475 A1
(43) Pub. Date: Dec. 4, 2008

(54) Developer for Development of Electrostatic Image and Production Process Thereof

(75) Inventor: Hiroto Kidokoro, Tokyo (JP)

Correspondence Address: KRATZ, QUINTOS & HANSON, LLP, 1420 K Street, N.W., Suite 400, WASHINGTON, DC, 20005, US

(73) Assignee: Zeon Corporation,, Tokyo (JP)

(21) Appl. No.: 11/659,092

(22) PCT Filed: Aug. 3, 2005
(86) PCT No.: PCT/JP2005/014603

§ 371 Date: Feb. 1, 2007

(30) Foreign Application Priority Data
Aug. 3, 2004 (JP) 2004-226333

(51) Int. Cl. G03G 9/087; G03G 9/08; G03G 5/00

(52) U.S. Cl. 430/108.4; 430/110.3; 430/105; 430/110.1; 430/110.4; 430/110.2; 430/108.7; 430/137.15

(57) ABSTRACT

A developer for development of electrostatic images, comprising colored particles containing a binder resin, a colorant and a parting agent, and an external additive, wherein the developer has properties that a work function is at least 5.70 eV; when excitation energy (eV) in the measurement of the work function is plotted on an axis of abscissa, and a normalized photoelectron yield represented by the 0.5th power of a photoelectron yield per unit photon is plotted on an axis of ordinate, a gradient of the normalized photoelectron yield to the excitation energy is at least 15/eV; and an extraction quantity with methanol is 5.0% by weight or less, and a production process thereof.

### TECHNICAL FIELD

The present invention relates to a developer (hereinafter may be referred to as “toner” merely) for development of electrostatic images, which is used in development of electrostatic images (electrostatic latent images) formed by an electrophotographic process in image forming apparatus using an electrophotographic system, such as copying machines, facsimiles and printers, and a production process thereof.

In the present invention, colored polymer particles obtained by a polymerization process may be referred to as “a polymerized toner”, and colored resin particles obtained by a pulverization process may be referred to as “a pulverized toner”. Both colored polymer particles and colored resin particles are referred to as “colored particles”. For example, a one-component developer obtained by adding an external additive to the colored particles and a two-component developer obtained by mixing the colored particles with carrier particles are representative of the developer (toner) for development of electrostatic images. Even in the two-component developer, colored particles, to which the external additive is added, are often used.

### BACKGROUND ART

In recent years, to impart high function and to form color images have been advanced in image forming apparatus using an electrophotographic system, such as copying machines, facsimiles and printers. With the advancement of such high-performance image forming apparatus, developers (toners) used in development of electrostatic images formed on a photosensitive member are also required to have better image reproducibility, and high durability and environmental stability.

In the electrophotographic system, an electrostatic latent image is formed on a photosensitive member formed by using a photoconductive substance by means of any of various means. The electrostatic latent image on the photosensitive member is developed with a toner into a toner image. This toner image is transferred to a recording material such as paper or an OHP sheet and then fixed to the recording material by heat, pressure or the like. The toner (hereinafter referred to as “toner remaining after transfer”) remaining on the photosensitive member without being transferred upon the transfer of the toner image on the photosensitive member to the recording material is recovered by a cleaning step. As a cleaning method, a blade cleaning method, in which a cleaning blade is brought into contact with the surface of the photosensitive member to remove the toner remaining on the photosensitive member after transfer, is widely used in that the apparatus can be made compact, and operation is also simple.

As a method for obtaining a toner good in image reproducibility, it is proposed to make the particle diameter of colored particles making up the toner small. However, the mere fact that the particle diameter of the colored particles is made small deteriorates the transferability of a toner image formed on a photosensitive member to a recording material because the adhesive force of such colored particles to the surface of the photosensitive member becomes too great. When colored resin particles (pulverized toner) having a small particle diameter, which are obtained by the pulverization process, are used, the transferability is particularly deteriorated. When the transferability of the toner is deteriorated, the amount of the toner remaining on the photosensitive member after transfer increases in addition to the deterioration of image reproducibility, so that difficulty is encountered upon the removal of the toner by cleaning, or the cause of lowering of printing durability is formed.

As a method for preventing the transferability from being deteriorated even when the particle diameter of the colored particles is made small, there is proposed a developer (toner) using, as colored particles, spherical and small-sized colored polymer particles (polymerized toner) produced by the polymerization process. Since the spherical and small-sized colored polymer particles are small in the contact area with the photosensitive member, its adhesive force to the surface of the photosensitive member is relatively small. Therefore, the toner containing the colored polymer particles is excellent in transferability. However, when an image is formed with the toner containing the colored polymer particles, the toner slightly remaining on the photosensitive member after transfer is easy to causes a phenomenon (cleaning failure) that the toner passes through between a cleaning blade and the surface of the photosensitive member in a cleaning step, and so such a toner involves a problem that it is liable to become difficult to be cleaned off.

When the cleaning ability of a toner is deteriorated, the toner remaining after transfer is not cleaned off, but remains on the photosensitive member as it is, so that a problem of deterioration of an image due to the defective formation of an electrostatic latent image arises in a subsequent image forming step. In addition, a problem of color mixing also arises in the formation of an image with color toners. Accordingly, toners used in the formation of the image with color toners are required to have higher cleaning ability than in the formation of an image with a monochromatic toner. Various kinds of organic pigments used as colorants for color toners have a feature that their charging ability is high compared with carbon black commonly used as a colorant for the monochromatic toner. Therefore, in such a color toner, the toner remaining after transfer more strongly electrostatically adheres to the surface of the photosensitive member and is thus liable to become difficult to be cleaned off.

Japanese Patent Application Laid-Open No. 2004-177747 has proposed a toner for development of electrostatic latent images, comprising an external additive, which contains silica-coated metal oxide particles having a core-shell structure that the core layer is composed of a metal oxide selected from the group consisting of titanium dioxide, aluminum oxide and zinc oxide, and the shell layer is composed of silica, and fine silica particles having a volume average particle diameter of 5 to 20 nm, and colored particles. However, this toner has been insufficient in improvement from the point of view of easy cleaning and involved a problem that a printing density is lowered under a low-temperature and low-humidity environment.

Japanese Patent Application Laid-Open No. 6-11898 has proposed a full-color toner kit that is an image forming toner kit having at least a magenta toner, a cyan toner, a yellow toner and a black toner, in which a difference in work function between the respective color toners is at most 0.5 eV. This full-color toner kit can exhibit stable color reproducibility under various environments by making the difference in work function between the respective color toners small to control the electrostatic adhesive force of each of the color toners to the surface of the photosensitive member. In this toner kit, however, an improving effect is scarcely found from the point of view of easy cleaning though stable color reproducibility is achieved by making the difference in work function between the respective color toners.

### DISCLOSURE OF THE INVENTION

It is an object of the present invention to provide a developer for development of electrostatic images, which comprises color particles and an external additive and is very easy to be cleaned off even when endurance printing is conducted and also excellent in environmental stability and printing durability.

The present inventors have paid attention to work functions of developers (toners) for development of electrostatic images to carry out an extensive investigation. As a result, it has been found that the work function of a toner is controlled so as to reach at least a specific value, a gradient Y (=normalized photoelectron yield/excitation energy) (unit=eV⁻¹; also indicated as “1/eV”) of a normalized photoelectron yield to excitation energy is controlled so as to reach at least a specific value, and an extraction quantity with methanol is controlled to a specific amount or less, whereby the above object can be achieved. In order to produce a toner having such properties, when colored particles are colored polymer particles, a process, in which after the colored polymer particles are obtained by a polymerization step, the colored polymer particles are washed with an organic solvent, is effective. As the organic solvent, is used an organic solvent, which does not dissolve the colored polymer particles, such as an alcohol.

According to the present invention, there is thus provided a developer for development of electrostatic images, comprising colored particles containing a binder resin, a colorant and a parting agent, and an external additive, wherein the developer has the following properties:

(a) a work function is at least 5.70 eV,

(b) when excitation energy (eV) in the measurement of the work function is plotted on an axis of abscissa, and a normalized photoelectron yield represented by the 0.5th power of a photoelectron yield per unit photon is plotted on an axis of ordinate, a gradient of the normalized photoelectron yield to the excitation energy is at least 15/eV, and

(c) an extraction quantity with methanol is 5.0% by weight or less.

According to the present invention, there is also provided a process for producing a developer for electrostatic image development, comprising the following Steps 1 to 4:

(1) Step 1 of dispersing a polymerizable monomer composition containing a polymerizable monomer, a colorant and a parting agent in an aqueous medium by high shear stirring to form droplets of the polymerizable monomer composition;
(2) Step 2 of raising the temperature of the aqueous medium containing the droplets to a polymerization temperature in the presence of a polymerization initiator to conduct polymerization of the polymerizable monomer composition;
(3) Purification Step 3 of separating colored polymer particles formed after the polymerization from the aqueous medium containing the colored polymer particles by filtration, washing the colored polymer particles with water to purify them, and at this time additionally conducting washing with an organic solvent that does not dissolve the colored polymer particles; and
(4) Step 4 of adding an external additive to colored polymer particles obtained by drying,
wherein the developer has properties that (a) a work function is at least 5.70 eV, (b) when excitation energy (eV) in the measurement of the work function is plotted on an axis of abscissa, and a normalized photoelectron yield represented by the 0.5th power of a photoelectron yield per unit photon is plotted on an axis of ordinate, a gradient of the normalized photoelectron yield to the excitation energy is at least 15/eV, and (c) an extraction quantity with methanol is 5.0% by weight or less.

The colored particles preferably have an average circularity within a range of 0.940 to 0.980. As a method for controlling the average circularity of the colored particles, in the case where the colored particles are the above-described colored polymer particles, is preferably adopted a method, in which the above-described Step 2 includes a secondary process composed of the following Steps 2-1 to 2-3:

(I) Step 2-1 of raising the temperature of the aqueous medium containing the droplets to a polymerization temperature in the presence of a polymerization initiator to initiate polymerization of the polymerizable monomer composition;
(II) Step 2-2 of lowering the temperature of the aqueous medium to a temperature lower than the polymerization temperature while the conversion of the polymerizable monomer into a polymer falls within a range of 25 to 95%, and conducting high shear stirring again; and
(III) Step 2-3 of raising the temperature of the aqueous medium to the polymerization temperature again to continue the polymerization until the conversion of the polymerizable monomer into the polymer reaches at least 98%.

The parting agent is preferably an esterified product of a polyhydric alcohol and a carboxylic acid. The proportion of the parting agent incorporated is preferably within a range of 1 to 20 parts by weight per 100 parts by weight of the binder resin component forming the colored polymer particles. Accordingly, when the colored particles are colored polymer particles, the parting agent is preferably used in a proportion of 1 to 20 parts by weight per 100 parts by weight of the polymerizable monomer upon the preparation of the polymerizable monomer composition.

The charge level of the toner according to the present invention is preferably within a range of 50 to 120° C./g in terms of an absolute value |Q|.

The toner according to the present invention preferably contains, as the external additive, fine silica particles (A), the number average particle diameter of primary particles of which is 5 to 20 nm, or spherical fine silica particles (B) having a volume average particle diameter of 0.1 to 0.5 μm and a spheroidicity of 1.0 to 1.3, or a mixture thereof. Fine silica particles (C), the number average particle diameter of primary particles of which is greater than 20 nm, but not greater than 100 nm, are preferably used as an external additive in combined.

### BRIEF DESCRIPTION OF THE DRAWINGS

FIG. 1 is a graph illustrating a work function X and a gradient Y of a normalized photoelectron yield to excitation energy (eV) when the excitation energy (eV) in the measurement of the work function is plotted on an axis of abscissa, and a normalized photoelectron yield represented by the 0.5th power of a photoelectron yield per unit photon is plotted on an axis of ordinate.

### BEST MODE FOR CARRYING OUT THE INVENTION

The toner according to the present invention is a developer for development of electrostatic images, comprising colored particles containing a binder resin, a colorant and a parting agent, and an external additive.

The toner according to the present invention has properties that (a) a work function is at least 5.70 eV, (b) when excitation energy (eV) in the measurement of the work function is plotted on an axis of abscissa, and a normalized photoelectron yield represented by the 0.5th power of a photoelectron yield per unit photon is plotted on an axis of ordinate, a gradient of the normalized photoelectron yield to the excitation energy is at least 15/eV, and (c) an extraction quantity with methanol is 5.0% by weight or less.

The work function means minimum energy required to take electrons out from the solid. In other words, the work function is defined as minimum energy required to take out electrons in a solid, which are bound like electrons in an atom, from the surface of the solid. The work function is known as an important quantity participating in a contact potential difference in the surface of a solid, an electron emission phenomenon, chemical activation and the like.

The work function is an energy level characteristic of a substance, and the work function of the toner means an energy level, which becomes a threshold value at which the toner starts emitting electrons. The value of the work function can be gained by measuring a photoelectrical work function by means of a photoelectronic spectrometer (“MODEL AC-2”, manufactured by Riken Keiki Co., Ltd.). A heavy hydrogen light source of 500 nW is used as a UV light source for exciting a sample, the sample is irradiated with monochromatized incident light (spot size: 2 to 4 mm) while scanning the energy of the incident light from 3.4 eV to 6.2 eV, and photoelectrons emitted from the surface of the sample are counted by a counter to determine a normalized photoelectron yield to the excitation energy (eV).

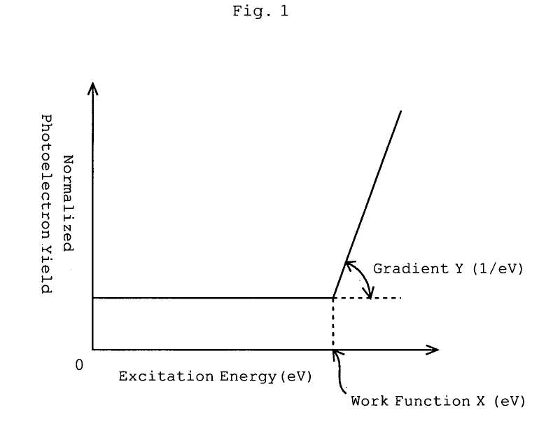

FIG. 1 illustrates a general tendency of a graph, in which the excitation energy (unit=eV) in the measurement of the work function of the toner is plotted on an axis of abscissa, and the normalized photoelectron yield is plotted on an axis of ordinate. In the present invention, the normalized photoelectron yield means a value obtained by raising a photoelectron yield per unit photon to 0.5th power. When excitation energy by incident light is scanned from a lower side in the graph in FIG. 1, a flat portion where no normalized photoelectron yield changes continues in a region of low excitation energy levels, and the normalized photoelectron yield starts rapidly increasing at the time the excitation energy has reached a certain level. This point of change, at which the normalized photoelectron yield starts increasing, is the work function X (eV) of the toner that is an object of measurement.

In a region where the excitation energy is not smaller than the work function X (eV), a gradient in a region where the rate of change in the graph is stable is the gradient Y (unit=eV⁻¹ or 1/eV) of the normalized photoelectron yield to the excitation energy. The flat portion where no normalized photoelectron yield changes in the region of low excitation energy levels does not affect the value of this gradient Y.

In order to measure the work function of a toner by means of the photoelectronic spectrometer (“MODEL AC-2”, manufactured by Riken Keiki Co., Ltd.), about 5 g of the toner is first placed and evenly spread on a holder for measurement. A heavy hydrogen light source of 500 nW is used as a UV light source, and the toner is irradiated with monochromatized incident light (spot size: 2 to 4 mm) while scanning the energy of the incident light every 0.1 eV from 3.4 eV to 6.2 eV to determine a normalized photoelectron yield to the excitation energy.

The work function X of the toner and the gradient of the normalized photoelectron yield to the excitation energy are determined from the measured values obtained by the above-described measurement in accordance with the following method. Namely, the measured values obtained by the measurement are plotted with the excitation energy and the normalized photoelectron yield taken on an axis of abscissa and an axis of ordinate, respectively. A proper number of measuring points are then picked up from the flat region just before the measured value plotted rises on the graph to average the values of the normalized photoelectron yield, thereby preparing a base line.

More specifically, an average value is determined from the values of the normalized photoelectron yield of 11 points at intervals of 0.1 eV within an excitation energy range of 4.2 to 5.2 eV to prepare a base line. When the values of the normalized photoelectron yield continuously increase within a range (4 points at intervals of 0.1 eV) of 0.3 eV from the value of the base line, a primary straight line is determined within a range from a value greater by 0.2 eV than the value of the excitation energy at the point (the first point among the 4 points) where the value of the normalized photoelectron yield has started increasing to 6.2 eV to regard the gradient thereof as the gradient Y (eV⁻¹) of the normalized photoelectron yield to the excitation energy. Further, the excitation energy at an intersection between the primary straight line and the base line is regarded as the work function X (eV).

The work function is minimum energy required to take out electrons from the outermost portion of a substance and a value characteristic of each substance. The work function indicates that electrons are easier to be emitted as its value becomes smaller, whereas electrons are harder to be emitted as its value becomes greater. On the other hand, a greater gradient of the normalized photoelectron yield to the excitation energy indicates a state that a greater amount of electrons are easy to be emitted.

The work function and the gradient of the normalized photoelectron yield to the excitation energy of a toner are considered to have extremely close relation to contact charging of the toner. It is considered that when these values are controlled within the above-described respective ranges, whereby the degree of electrostatic adhesion of the toner to the surface of a photosensitive member is moderately controlled.

The work function X of the toner according to the present invention is at least 5.70 eV, preferably at least 5.8 eV. The upper limit of the work function is generally 7.00 eV, often 6.50 eV. The gradient Y of the normalized photoelectron yield to the excitation energy of the toner according to the present invention is at least 15/eV, preferably at least 20/eV. The upper limit of the gradient Y is generally 40/eV, often 35/eV. The work function and the gradient Y of the toner fall within the above respective ranges, whereby endurance printing ability and cleaning ability can be balanced with each other at a high level.

The extraction quantity (%) with methanol of the toner can be obtained by extracting a methanol-soluble component present in the vicinity of the surface of the toner by a Soxhlet extraction method to determine a change (weight loss) in weight of the toner before and after the extraction and calculating out a proportion to the weight of the toner before the extraction. The extraction quantity with methanol of the toner according to the present invention is 5.0% by weight or less, preferably 4.5% by weight or less, more preferably 4.0% by weight or less. When the extraction quantity with methanol of the toner becomes great, such a toner shows a tendency to lower the environmental stability. The lower limit of the extraction quantity with methanol of the toner is generally 0.5% by weight, often 1.0% by weight or 2.0% by weight.

The toner according to the present invention is preferably a toner obtained by polymerizing a polymerizable monomer composition containing a polymerizable monomer, a colorant and a parting agent in the presence of a polymerization initiator in an aqueous medium to obtain colored polymer particles and then mixing an external additive with the colored polymer particles. As the polymerization process, is particularly preferably used a suspension polymerization process.

The process for producing the toner by the suspension polymerization process will be described in detail. A colorant, a parting agent and optional other additives are first added to a polymerizable monomer and dissolved or dispersed to prepare a polymerizable monomer composition. After this polymerizable monomer composition is then poured into an aqueous medium containing a dispersion stabilizer, and the resultant mixture is stirred to form droplets (formation of droplets) of the polymerizable monomer composition, polymerization is conducted in the presence of a polymerization initiator to obtain an aqueous medium (hereinafter referred to as “aqueous dispersion”) containing colored polymer particles formed. Thereafter, the aqueous dispersion is filtered to separate the colored polymer particles, and the colored polymer particles are washed, dehydrated and dried. An external additive is added to the dry colored polymer particles obtained in such a manner to provide a toner. In order to provide a two-component developer, the colored polymer particles are mixed with a carrier.

More specifically, the toner according to the present invention can preferably be produced by a production process comprising the following Steps 1 to 4:

(1) Step 1 of dispersing a polymerizable monomer composition containing a polymerizable monomer, a colorant and a parting agent in an aqueous medium by high shear stirring to form droplets of the polymerizable monomer composition;
(2) Step 2 of raising the temperature of the aqueous medium containing the droplets to a polymerization temperature in the presence of a polymerization initiator to conduct polymerization of the polymerizable monomer composition;
(3) Purification Step 3 of separating colored polymer particles formed after the polymerization from the aqueous medium containing the colored polymer particles by filtration, washing the colored polymer particles with water to purify them, and at this time additionally conducting washing with an organic solvent that does not dissolve the colored polymer particles; and
(4) Step 4 of adding an external additive to colored polymer particles obtained by drying.

The colored polymer particles according to the present invention preferably have an average circularity within a range of 0.940 to 0.980. In order to produce colored polymer particles having an average circularity within this range, the above-described Step 2 desirably includes a secondary process composed of the following Steps 2-1 to 2-3:

(I) Step 2-1 of raising the temperature of the aqueous medium containing the droplets to a polymerization temperature in the presence of a polymerization initiator to initiate polymerization of the polymerizable monomer composition;
(II) Step 2-2 of lowering the temperature of the aqueous medium to a temperature lower than the polymerization temperature while the conversion of the polymerizable monomer into a polymer falls within a range of 25 to 95%, and conducting high shear stirring again; and
(III) Step 2-3 of raising the temperature of the aqueous medium to the polymerization temperature again to continue the polymerization until the conversion of the polymerizable monomer into the polymer reaches at least 98%.

The colored particles used in the present invention are preferably colored particles of a core-shell structure, more preferably colored polymer particles of a core-shell structure. In order to obtain the colored polymer particles of the core-shell structure, it is preferable to adopt a process further arranging, after the above-described Step 2, Step 2B of pouring a polymerizable monomer for shell into the aqueous medium containing the colored polymer particles formed and polymerizing the polymerizable monomer for shell to form a polymer layer on each surface of the colored polymer particles. By this process, the colored polymer particles of the core-shell structure that the colored polymer particles formed by the polymerization of the polymerizable monomer composition are used as core particles, and the polymer layer (shell) is formed on each surface of the core particles are obtained.

### (1) Polymerizable Monomer Composition

In the present invention, the polymerizable monomer means a polymerizable compound. A monovinyl monomer is preferably used as a main component of the polymerizable monomer. Examples of the monovinyl monomer include styrene; styrene derivatives such as vinyltoluene and α-methylstyrene; acrylic acid and methacrylic acid; acrylate compounds such as methyl acrylate, ethyl acrylate, propyl acrylate, butyl acrylate, 2-ethylhexyl acrylate and dimethylaminoethyl acrylate; methacrylate compounds such as methyl methacrylate, ethyl methacrylate, propyl methacrylate, butyl methacrylate, 2-ethylhexyl methacrylate and dimethylaminoethyl methacrylate; unsaturated nitrile compounds such as acrylonitrile and methacrylonitrile; acrylic acid derivatives and methacrylic acid derivatives such as acrylamide and methacrylamide; olefins such as ethylene, propylene and butylene; vinyl halides and vinylidene halides such as vinyl chloride, vinylidene chloride and vinyl fluoride; vinyl esters such as vinyl acetate and vinyl propionate; vinyl ethers such as vinyl methyl ether and vinyl ethyl ether; vinyl ketones such as vinyl methyl ketone and methyl isopropenyl ketone; and nitrogen-containing vinyl compounds such as 2-vinylpyridine, 4-vinylpyridine and N-vinylpyrrolidone.

These monovinyl monomers may be used either singly or in any combination thereof. As the monovinyl monomers, styrene, styrene derivatives and acrylate or methacrylate compounds are preferably used.

The monovinyl monomer(s) may preferably be selected in such a manner that the glass transition temperature Tg of a polymer (including a copolymer) obtained by polymerizing it (them) is generally 80° C. or lower, preferably 30 to 80° C., more preferably 40 to 70° C. The Tg of the polymer component of the toner can be calculated by calculation according to the kind(s) and proportion(s) of the polymerizable monomer(s) used in accordance with a method known per se in the art.

In order to improve the hot offset of the resulting toner upon fixing, a crosslinkable polymerizable monomer (hereinafter also referred to as “crosslinkable monomer”) is preferably used together with the monovinyl monomer. The crosslinkable monomer means a monomer having at least two polymerizable functional groups. As examples of the crosslinkable monomer, may be mentioned aromatic divinyl compounds such as divinylbenzene, divinylnaphthalene and derivatives thereof; unsaturated polycarboxylic acid polyesters of polyhydric alcohols, such as ethylene glycol dimethacrylate and diethylene glycol dimethacrylate; other divinyl compounds such as N,N-divinylaniline and divinyl ether; and compounds having three or more vinyl groups. These crosslinkable monomers may be used either singly or in any combination thereof. These crosslinkable monomers may be used either singly or in any combination thereof. In the present invention, the crosslinkable monomer is used in a proportion of generally 0.1 to 5 parts by weight, preferably 0.3 to 2 parts by weight per 100 parts by weight of the monovinyl monomer.

A macromonomer is preferably used as a polymerizable monomer together with the monovinyl monomer because a balance between the storage stability and the low-temperature fixing ability of the resulting toner can be improved. The macromonomer is a compound having a polymerizable carbon-carbon unsaturated double bond at its molecular chain terminal and is generally a reactive oligomer or polymer having a number average molecular weight within a range of 1,000 to 30,000.

The macromonomer is preferably that giving a polymer having a glass transition temperature higher than the glass transition temperature of a polymer obtained by polymerizing the monovinyl monomer. The amount of the macromonomer used is generally 0.01 to 10 parts by weight, preferably 0.03 to 5 parts by weight, more preferably 0.05 to 1 part by weight per 100 parts by weight of the monovinyl monomer.

As the colorant used in the present invention, a black colorant is used when a monochromatic toner is provided, while a black colorant, a yellow colorant, a magenta colorant and cyan colorant are respectively used when full-color toners are provides. Specific examples thereof include the following colorants.

As examples of black colorants, may be mentioned pigments such as carbon black, titanium black and magnetic powders (zinc iron oxide and nickel iron oxide and the like). Among these, carbon black is preferred, with carbon black having a primary particle diameter of 20 to 40 nm being more preferred. When the primary particle diameter of carbon black falls within above range, such carbon black can be evenly dispersed in the resulting toner, and fog is also lessened upon printing.

As the yellow colorant, may be used, for example, compounds such as azo colorants and fused polycyclic colorants. Specific examples thereof include C.I. Pigment Yellow 3, 12, 13, 14, 15, 17, 62, 65, 73, 74, 83, 90, 93, 97, 120, 138, 155, 180, 181, 185 and 186.

As the magenta colorant, may be used, for example, compounds such as azo colorants and fused polycyclic colorants. Specific examples thereof include C.I. Pigment Red 31, 48, 57, 58, 60, 63, 64, 68, 81, 83, 87, 88, 89, 90, 112, 114, 122, 123, 144, 146, 149, 150, 163, 170, 184, 185, 187, 202, 206, 207, 209 and 251; and C.I. Pigment Violet 19.

As the cyan colorant, may be used, for example, copper phthalocyanine compounds and derivatives thereof, and anthraquinone compounds. Specific examples thereof include C.I. Pigment Blue 2, 3, 6, 15, 15:1, 15:2, 15:3, 15:4, 16, 17 and 60.

The amount of each colorant used is generally 0.1 to 50 parts by weight, preferably 1 to 20 parts by weight, more preferably 2 to 10 parts by weight per 100 parts by weight of the monovinyl monomer.

As the parting agent, any parting agent may be used without particular limitation so far as it is generally used as a parting agent for toners. Examples of the parting agent include low-molecular weight polyolefin waxes such as low-molecular weight polyethylene, low-molecular weight polypropylene and low-molecular weight polybutylene; terminal-modified polyolefin waxes such as molecule terminal-oxidized low-molecular weight polypropylene, molecular terminal-epoxidized low-molecular weight polypropylene and block polymers of these compounds with low-molecular weight polyethylene, and molecule terminal-oxidized low-molecular weight polyethylene, molecular terminal-epoxidized low-molecular weight polyethylene and block polymers of these compounds with low-molecular weight polypropylene; natural waxes such as candelilla wax, carnauba wax, rice wax, Japan wax and jojoba wax; petroleum waxes such as paraffin wax, microcrystalline wax and petrolatum, and modified waxes thereof; mineral waxes such as montan, ceresin and ozokerite; synthetic waxes such as Fischer-Tropsch wax; and esterified products of a polyhydric alcohol with a carboxylic acid, such as pentaerythritol tetramyristate, pentaerythritol tetrapalmitate, pentaerythritol tetrastearate and pentaerythritol tetralaurate. These parting agents may be used either singly or in any combination thereof.

Among these parting agents, the esterified products of a polyhydric alcohol with a carboxylic acid are preferred. As the polyhydric alcohol, are preferred pentaerythritol and dipentaerythritol. Examples of the carboxylic acid include aliphatic carboxylic acids having 10 to 30 carbon atoms, alicyclic carboxylic acids and aromatic carboxylic acids. Among these, palmitic acid, lauric acid and stearic acid are preferred.

Among these parting agents, the esterified products of a polyhydric alcohol with a carboxylic acid, such as pentaerythritol esters, whose endothermic peak temperatures fall within a range of generally 30 to 150° C., preferably 50 to 120° C., more preferably 60 to 100° C. as determined from a DSC curve upon heating thereof by a differential scanning calorimeter (DSC), and dipentaerythritol esters, whose endothermic peak temperatures fall within a range of 50 to 80° C. as determined likewise, are particularly preferred from the viewpoint of a balance between the fixing ability and the parting ability of the resulting toner.

The parting agent is used in a proportion of generally 0.1 to 30 parts by weight, preferably 1 to 20 parts by weight per 100 parts by weight of the monovinyl monomer.

As other additives, a molecular weight modifier is preferably used. Examples of the molecular weight modifier include mercaptans such as t-dodecylmercaptan, n-dodecyl-mercaptan, n-octylmercaptan and 2,2,4,6,6-pentamethyl-heptane-4-thiol. The molecular weight modifier may be generally added prior to the initiation of the polymerization or in the middle of the polymerization. The amount of the molecular weight modifier used is preferably 0.01 to 10 parts by weight, more preferably 0.1 to 5 parts by weight per 100 parts by weight of the monovinyl monomer.

As other additives, a charge control agent is preferably used. As the charge control agent, may be used various kinds of charge control agents having positively charging ability or negatively charging ability. For example, charge control agents such as metal complexes of organic compounds having a carboxyl group or a nitrogen-containing group, metallized dyes and nigrosine; and charge control resins such as quaternary ammonium group- or its salt group-containing copolymers and sulfonic group- or its salt group-containing copolymers may be used. In the present invention, the quaternary ammonium group or its salt group means a group composed of a quaternary ammonium or quaternary ammonium salt. Likewise, the sulfonic group or its salt group means a group composed of a sulfonic group or a sulfonic salt.

Among these, a charge control resin such as a quaternary ammonium group- or its salt group-containing copolymer, or a sulfonic group- or its salt group-containing copolymer is preferably used because the printing durability of the resulting toner is improved.

The charge control agent is used in a proportion of generally 0.01 to 10 parts by weight, preferably 0.03 to 8 parts by weight per 100 parts by weight of the monovinyl monomer.

### (2) Proplet Forming Step:

After the polymerizable monomer composition containing the polymerizable monomer, colorant, parting agent and optional other additives is dispersed in an aqueous medium containing a dispersion stabilizer, and a polymerization initiator is added to the resultant dispersion liquid, droplets of the polymerizable monomer are formed. In order to inhibit premature polymerization, the polymerization initiator may also be added to the aqueous medium in the middle of the droplet forming step to cause it to migrate into the droplets of the polymerizable monomer composition.

No particular limitation is imposed on the method for forming the droplets. However, the formation is conducted by means of, for example, a device capable of strongly stirring, such as an in-line type emulsifying and dispersing machine (manufactured by Ebara Corporation, trade name “MILDER”) or a high-speed emulsifying and dispersing machine (manufactured by Tokushu Kika Kogyo Co., Ltd., trade name “T.K. Homomixer MARK II Type”). By the droplet forming step, droplets of the polymerizable monomer composition are formed in the aqueous medium. In the droplet forming step, high shear stirring is conducted at a rotating speed of generally 5,000 to 25,000 rpm, preferably 10,000 to 20,000 rpm by means of such a dispersing machine as described above.

The aqueous medium used in the present invention may be water alone. However, a solvent soluble in water may also be used in combination with water. Examples of the solvent soluble in water include alcohols (methanol, isopropanol, ethylene glycol, etc.), dimethylformamide, tetrahydrofuran and lower ketones (acetone, methyl ethyl ketone, etc.).

A dispersion stabilizer is preferably contained in the aqueous medium for the purpose of improving the dispersibility and stability of the droplets of the polymerizable monomer composition. Examples of the dispersion stabilizer include metallic compounds, such as sulfates such as barium sulfate and calcium sulfate; carbonates such as barium carbonate, calcium carbonate and magnesium carbonate; phosphates such as calcium phosphate; metal oxides such as aluminum oxide and titanium oxide; and metal hydroxides such as aluminum hydroxide, magnesium hydroxide and ferric hydroxide. As the dispersion stabilizer, may also be used an organic compound, such as a water-soluble polymer such as polyvinyl alcohol, methyl cellulose or gelatin; an anionic surfactant; a nonionic surfactant; or an amphoteric surfactant. The dispersion stabilizers may be used either singly or in any combination thereof.

Among the dispersion stabilizers, the metallic compounds are preferred. In particular, the metal hydroxides, which become hardly water-soluble colloid, are particularly preferred because the particle diameter distribution of the resulting colored polymer particles can be narrowed, the amount of the dispersion stabilizer remaining after washing can be lessened, the resulting toner can brightly reproduce images, and environmental stability is not deteriorated. Colloid of a hardly water-soluble metal hydroxide can be formed by, for example, adjusting the pH of an aqueous solution of a water-soluble polyvalent metallic compound to 7 or higher. Colloid of a hardly water-soluble metal hydroxide formed by reacting a water-soluble polyvalent metallic compound with an alkali metal hydroxide salt in a water phase is more preferred.

In the colloid of the hardly water-soluble metal hydroxide, it is preferable that the particle diameter (Dp50), the accumulating total of particles counted from the small particle diameter side in the number particle diameter distribution of which is 50%, be at most 0.5 μm, and the particle diameter (Dp90), the accumulating total of particles counted likewise from the small particle diameter side of which is 90%, be at most 1 μm. When the particle diameter of the colloid falls within this range, the polymerization stability of the polymerizable monomer composition is improved.

The amount of the dispersion stabilizer used is preferably 0.1 to 20 parts by weight per 100 parts by weight of the monovinyl monomer. If the amount of the dispersion stabilizer is too small, it is difficult to achieve sufficient polymerization stability, so that polymer aggregates are liable to be formed. If the amount is too great, the particle diameter of the resulting colored polymer particles becomes too small, so that a problem may be offered from the viewpoint of practical use.

As examples of the polymerization initiator used in the polymerization of the polymerizable monomer composition, may be mentioned persulfates such as potassium persulfate and ammonium persulfate; azo compounds such as 4,4′-azobis(4-cyanovaleric acid), 2,2′-azobis(2-methyl-N-(2-hydroxyethyl)propionamide), 2,2′-azobis(2-amidinopropane) dihydrochloride, 2,2′-azobis(2,4-dimethylvaleronitrile) and 2,2′-azobisisobutyronitrile; and peroxides such as di-t-butyl peroxide, benzoyl peroxide, t-butyl peroxy-2-ethylhexanoate, t-hexyl peroxy-2-ethylhexanoate, t-butyl peroxypivalate, di-isopropyl peroxydicarbonate, di-t-butyl peroxyisophthalate and t-butyl peroxyisobutyrate. Redox initiators obtained by combining the above-mentioned polymerization initiators with a reducing agent may also be used.

The amount of the polymerization initiator used is preferably 0.1 to 20 parts by weight, more preferably 0.3 to 15 parts by weight, most preferably 0.5 to 10 parts by weight per 100 parts by weight of the monovinyl monomer. The polymerization initiator may be added into the aqueous medium after the polymerizable monomer composition is dispersed in the aqueous medium and before the droplets are formed. However, the polymerization initiator may also be added into the polymerizable monomer composition in advance before the polymerizable monomer composition is dispersed in the aqueous medium.

### (3) Polymerization Step

The aqueous medium containing droplets of the polymerizable monomer composition is heated to start polymerization. The polymerization temperature of the polymerizable monomer composition varies according to the thermal decomposition temperature of the polymerization initiator used, but is preferably at least 50° C., more preferably 60 to 95° C. The polymerization is conducted for preferably 1 to 20 hours, more preferably 2 to 15 hours.

In the present invention, it is preferable to provide colored polymer particles of a core-shell structure by using the colored polymer particles obtained by the polymerization of the polymerizable monomer composition as core particles and forming a polymer layer (shell) on each outer surface of the core particles. According to the colored polymer particles of the core-shell structure, core particles composed of a material having a low softening point or low Tg are covered with a polymer layer having a softening point or Tg higher than that of the core particles, whereby a balance between lowering of a fixing temperature (fixing ability) and prevention of aggregation upon storage (storage stability) of the toner can be taken.

No particular limitation is imposed on the process for producing the colored polymer particles of the core-shell structure by using the colored polymer particles obtained by the polymerization of the polymerizable monomer composition as the core particles, and they can be produced in accordance with a process publicly known in the past. Among the publicly known processes, in-situ polymerization process and phase separation process are preferred from the viewpoint of production efficiency.

The production process of the colored polymer particles of the core-shell structure by the in-situ polymerization process will hereinafter be described. A polymerizable monomer (polymerizable monomer for shell) for forming a shell and a polymerization initiator are added into an aqueous medium, in which the colored polymer particles formed by the polymerization of the polymerizable monomer composition have been dispersed, to continue the polymerization, whereby colored polymer particles of the core-shell structure can be obtained.

As the polymerizable monomer for shell, may be used the same monomers as the polymerizable monomers mentioned above. Among these, polymerizable monomers or polymerizable monomer mixtures respectively obtaining polymers (including copolymers) having a Tg exceeding 80° C., such as styrene, acrylonitrile and methyl methacrylate, are preferably used either singly or in combination of two or more monomers thereof. The Tg of the polymer forming the shell is preferably higher than 80° C., but not higher than 120° C., more preferably 90 to 110° C.

As examples of polymerization initiators used in the polymerization of the polymerizable monomer for shell, may be mentioned water-soluble polymerization initiators, such as persulfates such as potassium persulfate and ammonium persulfate; and azo type initiators such as 2,2′-azobis(2-methyl-N-(2-hydroxyethyl)propionamide) and 2,2′-azobis-(2-methyl-N-(1,1-bis(hydroxymethyl)-2-hydroxyethyl)-propionamide). The amount of the polymerization initiator is generally 0.1 to 30 parts by weight, more preferably 1 to 20 parts by weight per 100 parts by weight of the polymerizable monomer for shell.

The polymerization temperature for forming the shell is generally at least 50° C., more preferably 60 to 95° C. The polymerization is conducted for generally 1 to 20 hours, preferably 2 to 15 hours.

### (4) Ellipse-Shaping Treatment Step

The colored particles according to the present invention preferably have an average circularity within a range of 0.940 to 0.980. In order to produce the colored polymer particles having an average circularity within the above range, the above-described Step 2 is preferably changed to an ellipse-shaping treatment step represented by the following Steps 2-1 to 2-3:

(I) Step 2-1 of raising the temperature of the aqueous medium containing the droplets to a polymerization temperature in the presence of the polymerization initiator to initiate polymerization of the polymerizable monomer composition;
(II) Step 2-2 of lowering the temperature of the aqueous medium to a temperature lower than the polymerization temperature while the conversion of the polymerizable monomer into a polymer falls within a range of 25 to 95%, and conducting high shear stirring again; and
(III) Step 2-3 of raising the temperature of the aqueous medium to the polymerization temperature again to continue the polymerization until the conversion of the polymerizable monomer into the polymer reaches at least 98%.

The temperature in the above-described Steps 2-1 and 2-3 is the polymerization temperature. In the above-described Step 2-2, the temperature of the aqueous medium is lowered to a temperature lower than the polymerization temperature while the conversion of the polymerizable monomer into the polymer falls within a range of 25 to 95%, preferably 30 to 90%, more preferably 40 to 80%, and high shear stirring is conducted again in a state that the progress of the polymerization reaction has been inhibited. In the high shear stirring, the same dispersing machine as that used in the droplet forming step is used to conduct the high shear stirring at a rotating speed of generally 5,000 to 25,000 rpm, preferably 10,000 to 20,000 rpm.

The high shear stirring is conducted in the middle of the polymerization step, whereby the colored polymer particles formed finally are considered to be shaped elliptically. If the conversion into the polymer is too low, the degree of shaping into the ellipse is liable to be insufficient even when the high shear stirring is conducted in the middle of the polymerization step. If the conversion into the polymer is too high, the degree of shaping into the ellipse is also liable to be insufficient.

The average circularity of the colored particles according to the present invention is preferably 0.940 to 0.980, more preferably 0.950 to 0.970. The average circularity of the colored particles according to the present invention is controlled within this range, whereby the transferability and cleaning ability of the toner can be balanced with each other at a high level.

### (5) Filtration, Washing, Dehydration and Drying

After completion of the polymerization, the aqueous dispersion (hereinafter referred to as “aqueous dispersion”) containing the colored polymer particles (including the colored polymer particles of the core-shell structure) obtained by the polymerization are purified by repeating operations such as washing, filtration, dehydration and drying several times as needed.

When a metallic compound such as a metal hydroxide is used as the dispersion stabilizer, as a washing process, is preferably adopted a process comprising adding an acid or alkali to the aqueous dispersion containing the colored polymer particles according to the kind of the metallic compound, thereby dissolving the dispersion stabilizer in water to remove it. When colloid of a hardly water-soluble metal hydroxide is used as the dispersion stabilizer, an acid is preferably added to the aqueous dispersion to adjust the pH thereof to 6.5 or lower. As the acid added, may be used an inorganic acid such as sulfuric acid, hydrochloric acid or nitric acid, or an organic acid such as formic acid or acetic acid. However, sulfuric acid is particularly preferred because of high removing efficiency and small burden on production equipment.

No particular limitation is imposed on a dehydration and filtration method, and various publicly known methods may be used. As examples thereof, may be mentioned centrifugal filtration, vacuum filtration and pressure filtration methods.

When low molecular compounds such as waxes and oligomers are present in a state exposed in the vicinity of the surfaces of the colored polymer particles after the filtration, washing and dehydration, the image quality of the resulting image may be adversely affected. In order to remove such low molecular compounds, it is preferable to adopt a method of additionally washing the colored polymer particles with an organic solvent. As the organic solvent used in the washing, is preferred a solvent which dose not dissolve the colored polymer particles and can be easily dried after the washing. Preferable organic solvents include alcohols. As the alcohols, are preferred lower alcohols having 1 to 5 carbon atoms, such as methanol and ethanol. The washing with the organic solvent is desirably conducted after the treatment for dissolving and removing the dispersion stabilizer with the acid or alkali, and the treatments such as filtration and water washing are conducted. The amount of the organic solvent used in the washing is such an amount that the extraction quantity with methanol of the toner is reduced to at most 5.0% by weight. The amount of the organic solvent used in the washing is preferably 100 to 500 parts by weight, more preferably 150 to 300 parts by weight per 100 parts by weight of the polymerizable monomer composition used in the polymerization.

No particular limitation is imposed on a drying method, and various methods may be used.

### (6) Toner

The volume average particle diameter Dv of the colored particles is preferably 3 to 15 μm, more preferably 4 to 12 μm. If the Dv is too small, the flowability of the resulting toner is lowered, so that such a toner may show a tendency to deteriorate transferability, cause blurring or lower a printing density in some cases. If the Dv is too great, the resolution of an image formed with such a toner may be lowered in some cases.

In the present invention, the average circularity of the colored particles is preferably 0.940 to 0.980, more preferably 0.950 to 0.970. If the average circularity of the colored particles is too high, the cleaning ability of such a toner may be deteriorated in some cases. If the average circularity is too low, such a toner may show a tendency to deteriorate transferability or lower the resolution of an image formed with such a toner in some cases.

A ratio Dv/Dp (which may be referred to as “particle diameter distribution”) of the volume average particle diameter Dv of the colored polymer particles making up the toner according to the present invention to the number average particle diameter Dp thereof is preferably 1.0 to 1.5, more preferably 1.0 to 1.3. If the Dv/Dp is too high, the resulting toner may show a tendency to cause blurring or lower transferability, printing density and resolution in some cases. The volume average particle diameter and number average particle diameter of the colored particles can be measured by means of, for example, a Multisizer (manufactured by Beckmann Coulter Co.).

The toner according to the present invention is provided as a one-component toner by mixing the colored particles and an external additive by means of a high-speed stirring machine such as a Henschel mixer in order to control the charging properties, flowability, storage stability and the like thereof, or as a two-component toner by mixing the colored particles, an external additive and carrier particles such as ferrite or iron powder.

As the external additive, may be used inorganic particles or organic resin particles generally used for the purpose of improving flowability and charging properties. Examples of the inorganic particles include fine particles of silica, aluminum oxide, titanium oxide, zinc oxide, tin oxide, calcium carbonate, calcium phosphate and cesium oxide. Examples of the organic resin particles include fine particles of methacrylic ester polymers, acrylic ester polymers, styrene-methacrylic ester copolymers, styrene-acrylic ester copolymers and melamine resins, and fine particles of a core-shell structure, in which the core is composed of a styrene polymer, and the shell is formed by a methacrylic ester polymer.

No particular limitation is imposed on the amount of the external additive added. However, it is generally 0.1 to 6 parts by weight, preferably 0.5 to 3 parts by weight per 100 parts by weight of the colored particles.

In the present invention, fine silica particles (A), the number average particle diameter of primary particles of which is 5 to 20 nm, are preferably used as an external additive. The fine silica particles (A) are more preferably subjected to a hydrophobicity-imparting treatment with a surface-treating agent such as a silane coupling agent, silicone oil, fatty acid or fatty acid metal soap. When the hydrophobicity-imparting treatment is conducted, the degree of hydrophobicity is preferably 40 to 95%. If the degree of hydrophobicity is too low, the resulting toner is greatly affected by an environment, and its charging is lowered under a high-temperature and high-humidity environment in particular, so that fog may be easy to occur in some cases. If the degree of hydrophobicity is too high on the other hand, rise in charging may occur under a low-temperature and low-humidity environment in some cases to lower a printing density.

The amount of the fine silica particles (A) added is preferably 0.1 to 2 parts by weight, more preferably 0.3 to 1.5 parts by weight per 100 parts by weight of the colored particles. The amount of the fine silica particles (A) added is controlled within the above range, whereby properties of the resulting toner, such as flowability, the image quality of an image formed with such a toner, and the like can be improved.

Spherical fine silica particles (B) having a volume average particle diameter of 0.1 to 0.5 μm are preferably used as an external additive. The spheroidicity of the spherical fine silica particles (B) is preferably 1.0 to 1.3, more preferably 1.0 to 1.2. The spherical fine silica particles (B) are more preferably subjected to the hydrophobicity-imparting treatment like the fine silica particles (A).

The amount of the spherical fine silica particles (B) added is preferably 0.1 to 2.5 parts by weight, more preferably 0.3 to 2.0 parts by weight per 100 parts by weight of the colored particles. If the amount of the spherical fine silica particles (B) added is too small, the cleaning ability of the resulting toner may be lowered in some cases. If the amount is too great, print soiling and fixing failure may occur in some cases upon printing with the resulting toner under a low-temperature and low-humidity environment.

In the toner according to the present invention, the fine silica particles (A), the number average particle diameter of primary particles of which is 5 to 20 nm, and the spherical fine silica particles (B) having a volume average particle diameter of 0.1 to 0.5 μm are preferably used in combination from the viewpoint of balancing properties of the resulting toner, such as flowability, transferability, cleaning ability, endurance printing ability and fixing ability, with one another at a high level.

In the toner according to the present invention, fine silica particles (C), the number average particle diameter of primary particles of which is greater than 20 nm, but not greater than 100 nm, may also be used as an external additive. The number average particle diameter of the fine silica particles (C) is preferably 30 to 90 nm. The fine silica particles (C) are preferably used in combination with the fine silica particles (A) and/or the spherical fine silica particles (B) from the viewpoint of the above-described properties of the resulting toner. The amount of the fine silica particles (C) added is preferably 0.1 to 2 parts by weight, more preferably 0.3 to 1.0 part by weight per 100 parts by weight of the colored particles.

The charge level of the toner is preferably 50 to 120° C./g, more preferably 60 to 100° C./g in terms of the absolute value |Q| of a blow-off charge level. If the absolute value |Q| of the blow-off charge level of the toner is too small, such a toner is easy to cause fag. If the absolute value is too great, the toner is easy to cause lowering of printing density and print soiling.

### EXAMPLES

The present invention will hereinafter be described more specifically by the following preparation examples, examples and comparative examples. In the following preparation examples, examples and comparative examples, all designations of “part” or “parts” and “%” mean part or parts by weight and % by weight unless expressly noted. In the present invention, the testing methods of properties or characteristics and physical properties are as follows.

### (1) Average Circularity of Toner

A container was charged with 10 ml of ion-exchanged water in advance, 0.02 g of a surfactant (alkylbenzene-sulfonic acid) as a dispersing agent was added thereto, and 0.02 g of colored particles were further added to conduct a dispersing treatment for 3 minutes at 60 W by means of an ultrasonic dispersing machine. The concentration of the colored particles upon measurement was adjusted to 3,000 to 10,000 particles/μL to measure a circularity as to 1,000 to 10,000 colored particles corresponding to circles having a diameter of 1 μm or greater by means of a Flow Particle Image Analyzer “FPIA-2100” manufactured by SYSMEX CORPORATION. An average circularity was found from the measured values. The circularity is represented by the following equation. The average circularity is a value obtained by averaging the circularities.

Circularity=(Peripheral length of a circle equal to the projected area of a particle)/(Peripheral length of the projected area of the particle)

### (2) Number Average Particle Diameter of Primary Particles of Fine Silica Particles (A)

The number average particle diameter of primary particles of fine silica particles was determined by photographing each of particles by an electron microscope, and processing the resultant photographs by means of an image processing analyzer “LUZEX IID” (manufactured by NIRECO Corporation) under conditions of an area rate of particles to a frame area of 2% in maximum and a total processing number of 100 particles to calculate out circle-corresponding diameters of the particles, thereby finding an average value thereof. The number average particle diameter of primary particles of fine silica particles (C) was also measured by the same measuring method.

### (3) Volume Average Particle Diameter of Spherical Fine Silica Particles (B)

After 0.5 g of spherical fine silica particles were placed in a 100-ml beaker, some drops of a surfactant were added dropwise, and 50 ml of ion-exchanged water was added to disperse the particles for 5 minutes by means of an ultrasonic homogenizer (manufactured by Nippon Seiki Co., Ltd., trade name “US-150T”), a volume average particle diameter and a particle diameter distribution were measured by means of a laser particle size distribution measuring device (manufactured by Nikkiso Co., Ltd., trade name “MICROTRACK UPA150”).

### (4) Spheroidicity of Spherical Fine Silica Particles (B)

The spheroidicity Sc/Sr that is a value obtained by dividing an area Sc of a circle supposing that the absolute maximum length of a spherical fine silica particle is a length by a substantial projected area Sr of the particle was determined by photographing each of the particles by an electron microscope, processing the resultant photographs by means of an image processing analyzer (manufactured by NIRECO Corporation, trade name “LUZEX IID”) under conditions of an area rate of particles to a frame area of 2% in maximum and a total processing number of 100 particles and averaging the thus-obtained spheroidicity values of the 100 particles.

Spheroidicity=Sc/Sr

wherein Sc: an area of a circle supposing that the absolute maximum length of a particle is a diameter,
Sr: a substantial projected area.
(5) Extraction Quantity (%) with Methanol

A toner was precisely weighed within a range of 0.8 to 1.0 g to regard it as a toner weight T₀ before extraction. This toner was placed in a thimble filter (product of Toyo Filter Paper Co., Ltd., trade name “No. 86R”) to measure the total weight T₁ of the weight of the thimble filter and the weight of the toner. This thimble filter, in which the toner had been placed, was placed in a Soxhlet extractor to conduct extraction with 100 ml of a methanol solvent for 6 hours. After the thimble filter, in which the toner had been placed, was air-dried for 12 hours after the extraction, it was vacuum-dried additionally for 1 hour at 50° C. The weight T₂ of the thimble filter after the vacuum drying, in which the toner had been placed, was measured to calculate out an extraction quantity (%) with methanol in accordance with the following equation:

Extraction quantity with methanol (%)=[T₁−T₂)/T₀]×100

### (6) Blow-Off Charge Level

The charge level of a toner was measured in the following manner. Namely, 59.7 g of a carrier (product of Powdertec K.K., trade name “TEFV 150/250”) and 0.3 g of the toner were weighed and placed into a 200-cc SUS-made pot. After rotating the pot for 30 minutes at a rotating speed of 150 rpm, the toner was blown off under a nitrogen gas pressure of 1 kg/cm² in a blow-off meter (manufactured by Toshiba Chemical Corporation, trade name “TB-100”), thereby measuring a charge level of the toner. The measurement was conducted at a temperature of 23° C. and a relative humidity of 50%.

### (7) Work Function

Measurement was conducted by means of a photoelectronic spectrometer (manufactured by Riken Keiki Co., Ltd., trade name “MODEL AC-2”,). About 0.5 g of a toner was placed and evenly spread on a holder for measurement. A heavy hydrogen light source of 500 nW was used as a UV light source, and the toner was irradiated with monochromatized incident light (spot size: 2 to 4 mm) while scanning the energy of the incident light from 3.4 eV to 6.2 eV to determine a normalized photoelectron yield to the excitation energy. The gradient of the normalized photoelectron yield to the excitation energy is determined by (normalized photoelectron yield/excitation energy). The details of the measuring method are as described above.

### <Imaging Test>

### (8) Fixing Temperature and Off Set Temperature of Toner

A printer obtained by modifying a commercially available printer (manufactured by Oki Data Corporation, trade name “MICROLINE 7300”, 24 paper sheets per minute printer) of the non-magnetic one-component development system in such a manner that the temperature of a fixing roll part can be varied was used to conduct a fixing test. The fixing test was conducted by varying the temperature of the fixing roll to determine a fixing rate of a toner at each temperature, thereby finding a relationship of temperature-fixing rate.

The fixing rate was calculated from a ratio of image densities before and after a peeling operation using a tape as to a black solid-printed area printed on paper for test by the above-described printer. More specifically, assuming that the image density before the peeling of the tape is ID (before), and the image density after the peeling of the tape is ID (after), the fixing rate can be calculated out in accordance with the following equation:

Fixing rate (%)=[ID(after)/ID(before)]×100

In this test, the peeling operation of the tape is a series of operations that an adhesive tape (product of Sumitomo 3M Limited, trade name “SCOTCH MENDING TAPE 810-3-18”) is applied to the measuring portion (black solid-printed area) of the paper for test to cause the tape to adhere to the paper by pressing the tape under a fixed pressure, and the adhesive tape is then peeled at a constant rate in a direction along the paper. The image density was measured by means of a reflection type image densitometer (manufactured by McBeth Co.). In this fixing test, a temperature of the fixing roll, at which the fixing rate of the toner amounted to at least 80%, was defined as a fixing temperature of the toner. A temperature of the fixing roll, at which an attachment of the toner remaining on the fixing roll was observed when the temperature of the fixing roll was raised at intervals of 5° C., was defined as an offset temperature.

### (9) N/N Initial Printing Density and H/H Initial Printing Density

After a toner was charged into a printer, and the printer was left to stand for a day under an environment (N/N environment) of 23° C. in temperature and 50% in humidity, printing was continuously conducted from the beginning at a printing density of 5% under the same environment, and solid printing was conducted upon printing on the tenth paper sheet to measure an initial printing density (N/N initial printing density) by means of a McBeth reflection type image density meter.

Likewise, the toner was charged into the printer, the printer was left to stand for a day under an environment (H/H environment) of 30° C. in temperature and 80% in humidity, and an initial printing density (H/H initial printing density) was measured.

### (10) Durability

After a toner was charged into the printer, and the printer was left to stand for a day under an N/N environment, printing was continuously conducted at a density of 5%. Every 500 sheets of paper, a printing density and fog were determined. The printing density was measured by means of a reflection type image densitometer (manufactured by McBeth Co.) as to a black solid-printed area on paper.

The fog was determined in the following manner. white solid printing was conducted, the printer was stopped in the middle of the printing, and a toner of a non-image area on a photosensitive member after development was applied to the above-described adhesive tape. This adhesive tape was stuck on new paper for printing to measure a color tone by means of a spectroscopic color-difference meter (manufactured by Nippon Denshoku K.K., trade name “SE-2000”). An unused adhesive tape was stuck on the paper for printing to measure a color tone as a reference likewise. Their color tones were represented as coordinates of the L*a*b* color space to calculate out a color difference ΔE from the color tones of the measured sample and reference sample to find a fog value. The smaller fog value indicates that fog is less, and image quality is better.

In the durability test, the number of sheets of paper, which could be subjected to continuous printing while retaining the above-described image density of 1.3 or higher and the fog value of 1% or lower, was determined in a range up to 10,000 sheets of paper. In the test result, “10,000” indicates that the image density value and the fog value satisfied the above condition even when printing was continuously conducted on 10,000 sheets of paper.

### (11) Cleaning Ability

After a cleaning blade sample for test was fitted to the above-described printer, and a toner was charged into a cartridge, and the printer was left to stand for a day under the N/N environment, printing was continuously conducted at a density of 5%. Every 500 sheets of paper, a photosensitive member and a charging roll were visually observed to evaluate whether stripes due to cleaning failure occurred or not. Whether cleaning failure occurred or not was tested up to 10,000 sheets of paper. The test result was indicated as the number of sheets of paper until the cleaning failure occurred. In the test result, “10,000” indicates that no cleaning failure occurred even when printing was continuously conducted on 10,000 sheets of paper.

### (12) Stripe Soiling or Black Spots

The above-described printer was used to continuously conduct printing at a printing density of 5% under the N/N environment. Every 500 sheets of paper, a solid image was printed for test to determine the number of sheets of paper until stripe soiling or black spots started occurring. The test was conducted up to 10,000 sheets of paper. In the test result, “10,000” indicates that neither stripe soiling nor black spots occurred even when printing was continuously conducted on 10,000 sheets of paper.

### Preparation Example 1

### Synthesis of Charge Control Resin 1

Into 900 parts of toluene, was poured 100 parts of a polymerizable monomer composed of 85% of styrene, 13% of n-butyl acrylate and 2% of 2-acrylamido-2-methylpropane-sulfonic acid, and the temperature of the resultant mixture was raised to 80° C. in the presence of 4 parts of azobisdimethylvaleronitrile as a polymerization initiator to conduct a reaction for 8 hours. After completion of the reaction, toluene was distilled off under reduced pressure to obtain a sulfonic group-containing copolymer. The weight average molecular weight (Mw) of the sulfonic group-containing copolymer was 22,000. This sulfonic group-containing copolymer is referred to as “a charge control resin 1”. The content of a structural unit having a functional group in the charge control resin 1 is 2%.

### Preparation Example 2

### Preparation of Spherical Fine Silica Particles 1

A hundred parts of mixed powder composed of 1.0 mol, in terms of an SiO₂ content, of silica powder (average particle diameter: 2 μm, maximum particle diameter: 60 μm) and 0.8 mol of metal silicon powder (average particle diameter: 10 μm, maximum particle diameter: 100 μm) was mixed with 50 parts of purified water, and the resultant mixture was placed in a thin-wall container to intermittently feed it to an electric oven of 2,000° C. After hydrogen gas was introduced from the same direction as in the feeding of the raw mixture to conduct a reaction, the hydrogen gas and generated gases were sucked by an exhaust blower provided at an upper part in an opposite direction in the oven, the mixture was brought into contact with air at a rate of 400 Nm³/hr, and spherical fine silica particles formed were collected by a bag filter while cooling them. The spherical fine silica particles were classified by an air classifier. The resultant spherical fine silica particles were such that the Dv50/Dv10 is 2.54, the volume average particle diameter of primary particles thereof is 0.2 μm, and the spheroidicity is 1.12.

Hexamethyldisilazane diluted with alcohol was added dropwise to the spherical fine silica particles thus classified in such a manner that the amount of hexamethyldisilazane amounts to 1% based on the spherical fine silica particles to be treated, and the resultant mixture was heated for 30 minutes at 70° C. while vigorously stirring the mixture. The solvent was then removed at 140° C., and the spherical fine particles thus obtained were subjected to a heat treatment for 4 hours at 210° C. while vigorously stirring them to obtain spherical fine silica particles subjected to a hydrophobicity-imparting treatment. The degree of hydrophobicity of the resultant spherical fine silica particles (referred to as “spherical fine silica particles 1”) was 70%, and the bulk density thereof was 110 g/liter.

### Example 1

A polymerizable monomer composition was obtained by wet-milling 80.5 parts of styrene, 19.5 parts of n-butyl acrylate, 0.6 part of divinylbenzene, 0.8 part of t-dodecylmercaptan and 6 parts of C.I. Pigment Blue 15:3 (product of Clariant Co.) as a cyan pigment by means of a media type wet mill (PICOMILL; manufactured by ASADA IRON WORKS CO., LTD.) and then adding, mixing and dissolving 5 parts of the negative charge control resin 1 obtained in Preparation Example 1 and 10 parts of dipentaerythritol hexamyristate (product of Nippon Oil & Fats Co., Ltd.).

On one hand, an aqueous solution with 6.6 parts of sodium hydroxide dissolved in 50 parts of ion-exchanged water was gradually added to an aqueous solution with 11.8 parts of magnesium chloride dissolved in 250 parts of ion-exchanged water with stirring to prepare an aqueous medium containing colloid of magnesium hydroxide.

On the other hand, 1 part of methyl methacrylate and 65 parts of ion-exchanged water were mixed to prepare an aqueous dispersion of a polymerizable monomer for shell.

The polymerizable monomer composition obtained above was poured into the colloidal dispersion of magnesium hydroxide obtained above, and the resultant mixture was stirred. After 6 parts of t-butyl peroxyisobutyrate (Perbutyl IB; product of Nippon Oil & Fats Co., Ltd.) as a polymerization initiator was added to the mixture, the resultant mixture was stirred 30 minutes at a rotating speed of 15,000 rpm under high shearing by means of an in-line type emulsifying and dispersing machine (manufactured by Ebara Corporation, trade name “MILDER”) to form droplets of the polymerizable monomer composition. A reaction container equipped with an agitating blade was charged with the aqueous medium, in which the droplets of the polymerizable monomer composition had been dispersed, and the aqueous medium was heated to 95° C. to start a polymerization reaction. After about 40 minutes (conversion of the polymerizable monomer into a polymer=about 60%), the temperature of the aqueous medium was lowered to 40° C., and high shear stirring was conducted for 5 minutes again at a rotating speed of 18,000 rpm by means of the above-described in-line type emulsifying and dispersing machine to perform an ellipse-shaping treatment.

After the ellipse-shaping treatment, the temperature of the aqueous medium was raised to 95° C. that was a polymerization temperature. After a conversion into a polymer reached almost 100%, 0.3 part of 2,2′-azobis[2-methyl-N-(2-hydroxyethyl)propionamide] (product of Wako Pure Chemical Industries, Ltd., trade name “VA-086”) as a polymerization initiator for the polymerizable monomer for shell was dissolved in the aqueous dispersion of the polymerizable monomer for shell, and the resultant solution was then added to the reaction container. After the polymerization was continued for 4 hours, the reaction was stopped to obtain an aqueous dispersion of colored polymer particles.

While stirring the thus-obtained aqueous dispersion of the colored polymer particles at room temperature, 10% sulfuric acid was added to the aqueous dispersion until its pH reached 4.5, thereby dissolving magnesium hydroxide. After this aqueous dispersion was filtered and dehydrated, 250 parts of ion-exchanged water of 40° C. was added to prepare an aqueous dispersion. This aqueous dispersion was filtered and dehydrated again. To this aqueous dispersion, was added 250 parts of methanol, and the resultant mixture was stirred for 1 hour and filtered and dehydrated. The thus-obtained colored polymer particles were dried to obtain colored polymer particles. The volume average particle diameter of the colored polymer particles was 6.7 μm.

To 100 parts of the colored polymer particles thus obtained, were added, as an external additive, 1 part of the spherical fine silica particles 1 (spheroidicity=1.12, degree of hydrophobicity=70%) having a volume average particle diameter of 0.2 μm and obtained in Preparation Example 2, and the resultant mixture was stirred for 5 minutes at a rotating speed of 1,400 rpm by means of a Henschel mixer. In addition, 1 part of fine silica particles (product of Nippon Aerosil Co., Ltd., trade name “R-104”, degree of hydrophobicity=45%), the number average particle diameter of primary particles of which was 12 nm, and 0.5 part of fine silica particles (product of Clariant Co., trade name “HDK-H05TX”; degree of hydrophobicity=80%), the number average particle diameter of primary particles of which was 50 nm, were added while cooling a jacket of the Henschel mixer with water, and the resultant mixture was stirred for 10 minutes at a rotating speed of 1,400 rpm to prepare a toner (magenta toner). The thus-obtained toner was subjected to the above-described tests. Polymerization formulation and composition, and the like are shown in Table 1, and test results are shown in Table 3.

### Example 2

A toner was prepared in the same manner as in Example 1 except that a yellow pigment, C.I. Pigment Yellow 180 (product of Clariant Co.) was used in place of the cyan pigment, C.I. Pigment Blue 15:3 (product of Clariant Co.) as the colorant in Example 1. The volume average particle diameter of the resultant colored polymer particles was 6.8 μm. The thus-obtained toner was subjected to the above-described tests. Polymerization formulation and composition, and the like are shown in Table 1, and test results are shown in Table 3.

### Example 3

A toner was prepared in the same manner as in Example 1 except that a yellow pigment, C.I. Pigment Red 122 (product of Clariant Co.) was used in place of the cyan pigment, C.I. Pigment Blue 15:3 (product of Clariant Co.) as the colorant in Example 1. The volume average particle diameter of the resultant colored polymer particles was 6.7 μm. The thus-obtained toner was subjected to the above-described tests. Polymerization formulation and composition, and the like are shown in Table 1, and test results are shown in Table 3.

### Example 4

A toner was prepared in the same manner as in Example 1 except that carbon black (trade name “#25B”, product of Mitsubishi Chemical Corporation) was used in place of the cyan pigment, C.I. Pigment Blue 15:3 (product of Clariant Co.) as the colorant in Example 1. The volume average particle diameter of the resultant colored polymer particles was 7.0 μm. The thus-obtained toner was subjected to the above-described tests. Polymerization formulation and composition, and the like are shown in Table 1, and test results are shown in Table 3.

### Comparative Example 1

Twenty-four parts of methyl ethyl ketone and 6 parts of methanol were dispersed in 100 parts of charge control resin (product of Fujikura Kasei Co., Ltd., trade name “FCA626N”; content of a structural unit having a sulfonic group: 7% by weight), and they were mixed by rolls while cooling them. At the time the charge control resin was rolled around the rolls, 100 parts of C.I. Pigment Yellow 180 (product of Clariant Co.) as a yellow colorant was gradually added and mixed for 1 hour to prepare a charge control resin composition. At this time, a roll nip was initially 1 mm, and the nip was then gradually widened to 3 mm at last. The organic solvent (methyl ethyl ketone/methanol=4/1 mixed solvent) was added several times according to the mixed state of the charge control resin. The organic solvent added was removed under reduced pressure after completion of the mixing.

Eighty-five parts of styrene, 15 parts of n-butyl acrylate, 0.725 part of divinylbenzene, 0.25 part of a polymethacrylic ester macromonomer (product of Toagosei Chemical Industry Co., Ltd., trade name “AA6”), 12 parts of the above-described charge control resin composition and 10 parts of dipentaerythritol hexamyristate were stirred, mixed and evenly dispersed to obtain a polymerizable monomer composition.

Separately from the above, an aqueous solution with 6.6 parts of sodium hydroxide dissolved in 50 parts of ion-exchanged water was gradually added to an aqueous solution with 10.8 parts of magnesium chloride dissolved in 250 parts of ion-exchanged water with stirring to prepare an aqueous medium containing colloid of magnesium hydroxide.

On the other hand, 2 parts of methyl methacrylate and 65 parts of water were subjected to a finely dispersing treatment by an ultrasonic emulsifier to obtain an aqueous dispersion of a polymerizable monomer for shell. The droplet diameter of droplets of the polymerizable monomer for shell was 1.6 μm in terms of D90.

The above-prepared polymerizable monomer composition was poured into the aqueous medium containing the colloid of magnesium hydroxide to stir the resultant mixture, and 1 part of triisobutylmercaptan (product of Bayer AG), 1 part of tetraethylthiuram disulfide (product of Ouchi-Shinko Chemical Industrial Co., Ltd.) and 5 parts of t-butyl peroxy-2-ethylhexanoate (product of Nippon Oil & Fats Co., Ltd., trade name “PERBUTYL 0”) were added. The resultant mixture was then stirred 30 minutes at a rotating speed of 15,000 rpm under high shearing by means of an (in-line type) emulsifying and dispersing machine (manufactured by Ebara Corporation, trade name “MILDER”) to form droplets of the polymerizable monomer composition, thereby preparing an aqueous dispersion of the polymerizable monomer composition. A reactor equipped with an agitating blade was charged with this aqueous medium of the polymerizable monomer composition, and the aqueous medium was heated to 90° C. to start a polymerization reaction. At the time a conversion into a polymer reached almost 100%, the aqueous dispersion of the polymerizable monomer for shell and 0.2 part of 2,2′-azobis[2-methyl-N-(2-hydroxyethyl)-propionamide] (product of Wako Pure Chemical Industries, Ltd., trade name “VA-086”) dissolved in 65 parts of distilled water were placed in the reactor. After the polymerization reaction was continued for 8 hours, the reaction was stopped to obtain an aqueous dispersion of colored polymer particles.

While stirring the thus-obtained aqueous dispersion of the colored polymer particles at room temperature, 10% sulfuric acid was added to the aqueous dispersion until its pH reached 5, thereby dissolving magnesium hydroxide. After this aqueous dispersion was filtered and dehydrated, 500 parts of ion-exchanged water of 40° C. was added to prepare an aqueous dispersion. This aqueous dispersion was filtered and dehydrated again, and water washing was conducted. After this water washing was conducted repeatedly 3 times, the thus-obtained colored polymer particles were dried to obtain colored resin particles having a volume average particle diameter Dv of 6.4 μm.

To 100 parts of the colored polymer particles thus obtained, were added 0.5 part of silica-coated metal oxide particles (product of Fuji Pigment Co., Ltd.; Al₂O₃—SDS) in which a core was composed of alumina, and a shell was composed of silica, and the number average particle diameter of primary particle of which was 90 nm, 0.5 part of silica, the number average particle diameter of primary particles of which was 12 nm, and 2.0 parts of silica, the number average particle diameter of primary particles of which was 40 nm, and the resultant mixture was mixed for 10 minutes at a rotating speed of 1,400 rpm by means of a Henschel mixer to obtain a toner. The thus-obtained toner was subjected to the above-described tests. Polymerization formulation and composition, and the like are shown in Table 2, and test results are shown in Table 3.

### Comparative Example 2

After 225 parts of a 0.1 M aqueous solution of Na₃PO₄ was poured into 350 parts of ion-exchanged water, and the resultant mixture was heated to 60° C., 33 g of 1.0 M CaCl₂ was gradually added to obtain an aqueous medium containing Ca(PO₄)₂. Eighty-five parts of styrene, 15 parts of n-butyl acrylate, 1.5 parts of a styrene-methyl acrylate-methyl methacrylate resin (weight average molecular weight=30,000), 25 parts of paraffin wax (melting point=70° C., ΔH=47 cal/g), 2.5 parts of a chromium di-t-butyl salicylate compound and 5 parts of Phthalocyanine Blue were heated to 60° C. and uniformly dispersed or dissolved by means of an Ebara Milder (manufactured by Ebara Corporation). Five parts of benzoyl peroxide was added thereto to prepare a polymerizable monomer composition.

The above-prepared polymerizable monomer composition was poured into the aqueous medium, and the resultant mixture was stirred for 20 minutes at 10,000 rpm by means of a TK Homomixer to form droplets of the polymerizable monomer composition. Thereafter, the resultant aqueous dispersion was heated to 60° C. to conduct a reaction for 0.5 hour. The conversion into a polymer at this point of time was 65%. The reflux of water vapor was then stopped, and the aqueous dispersion was heated to 80° C. and continuously stirred for 10 hours. After completion of the reaction, the reaction mixture was cooled, and hydrochloric acid was added to dissolve Ca₃(PO₄)₂, and filtration, washing and drying were conducted to obtain colored polymer particles having a weight average particle diameter of 8.2 μm.

To 100 parts of the colored polymer particles thus obtained, were added 0.7 parts by weight of hydrophobic silica (treated with a silane coupling agent) having a BET specific surface area of 200 m²/g, and the resultant mixture was mixed for 10 minutes at a rotating speed of 1,400 rpm by means of a Henschel mixer to obtain a toner. The thus-obtained toner was subjected to the above-described tests. Polymerization formulation and composition, and the like are shown in Table 2, and test results are shown in Table 3.

### Comparative Example 3

After a 4-necked flask was charged with 180 parts by weight of water and 20 parts by weight of a 0.2% by weight aqueous solution of polyvinyl alcohol which were purged with nitrogen, 85 parts by weight of styrene, 15 parts by weight of n-butyl acrylate and 5.0 parts by weight of benzoyl peroxide were added, and the resultant mixture was stirred to prepare a suspension. After the interior of the flask was purged with nitrogen, the suspension was heated to 80° C. to conduct a polymerization reaction for 10 hours, thereby obtaining a polymer.

After the thus-obtained polymer was washed with water, the temperature of the polymer was raised to 65° C. to dry the polymer under reduced pressure, thereby obtaining a resin. One hundred parts of this resin, 1.5 parts of a styrene-methyl acrylate-methyl methacrylate (weight average molecular weight=30,000), 2.5 parts of a chromium di-t-butyl salicylate compound, 5 parts of Phthalocyanine Blue and 25 parts of paraffin wax were mixed by means of a fixed bed dry mixer, the resultant mixture was melted and kneaded by means of a twin-screw extruder while sucking by connecting a vent port to a suction pump, thereby obtaining a melted and kneaded product.

After this melted and kneaded product was coarsely milled by means of a hammer mill, and the resultant coarse particles were ground to a volume average particle diameter of 20 to 30 μm by a mechanical grinder and further pulverized by means of a jet mill making good use of interparticle impingement in a revolving flow. The melted and kneaded product thus ground was modified by thermal and mechanical shearing force in a surface modifying machine and classified by a multi-division classifier to obtain colored polymer particles having an average particle diameter of 6.9 μm.

The colored polymer particles thus obtained were treated in the same manner as in Comparative Example 2 to prepare a toner. The thus-obtained toner was subjected to the above-described tests. Polymerization formulation and composition, and the like are shown in Table 2, and test results are shown in Table 3.

### Comparative Example 4

A toner was obtained in the same manner as in Comparative Example 1 except that after the aqueous dispersion of the polymerizable monomer composition in Comparative Example 1 was heated to 90° C., the droplets in the aqueous dispersion were subjected to the ellipse-shaping treatment using the above-described in-line type emulsifying and dispersing machine like Example 1, and the colored polymer particles were placed in a thickness of about 5 mm in a corona discharge type charge eliminator (manufactured by Keyence Corporation, trade name “SJ-F 100/010”) to subject them to a charge eliminating treatment by corona discharge for about 5 minutes. The thus-obtained toner was subjected to the above-described tests. Polymerization formulation and composition, and the like are shown in Table 2, and test results are shown in Table 3.

### Comparative Example 5

A toner was obtained in the same manner as in Comparative Example 2 except that the washing with methanol in Example 1 was conducted. The thus-obtained toner was subjected to the above-described tests. Polymerization formulation and composition, and the like are shown in Table 2, and test results are shown in Table 3.

TABLE 1

| | Ex. 1 | Ex. 2 | Ex. 3 | Ex. 4 |
|---|---|---|---|---|
| Binder resin | | | | |
| composition | | | | |
| (parts) | | | | |
| ST/BA | 80.5/19.5 | 80.5/19.5 | 80.5/19.5 | 80.5/19.5 |
| DVB | 0.6 | 0.6 | 0.6 | 0.6 |
| Colorant (parts) | | | | |
| PB15:3 | 6 | — | — | — |
| PY180 | — | 6 | — | — |
| PR122 | — | — | 6 | — |
| CB | — | — | — | 6 |
| Charge control | | | | |
| resin (parts) | | | | |
| CCR-1 | 5 | 5 | 5 | 5 |
| Parting agent | | | | |
| (parts) | | | | |
| DPEHM | 10 | 10 | 10 | 10 |
| Ellipse-shaping | Conducted | Conducted | Conducted | Conducted |
| treatment | | | | |
| Shell | Having | Having | Having | Having |
| MMA | 1 | 1 | 1 | 1 |
| Washing with | Conducted | Conducted | Conducted | Conducted |
| methanol | | | | |
| Volume average | 6.7 | 6.8 | 6.7 | 7.0 |
| particle diameter | | | | |
| (μm) | | | | |
| Particle diameter | 1.28 | 1.26 | 1.26 | 1.27 |
| distribution | | | | |
| External additive | | | | |
| Spherical fine | 1 | 1 | 1 | 1 |
| silica particles | | | | |
| (0.2 μm) | | | | |
| Fine silica | 1 | 1 | 1 | 1 |
| particles (12 μm) | | | | |
| Fine silica | 0.5 | 0.5 | 0.5 | 0.5 |
| particles (50 μm) | | | | |
| Production process | Polymeri- | Polymeri- | Polymeri- | Polymeri- |
| | zation | zation | zation | zation |
| | process | process | process | process |

TABLE 2

| | Comp. | Comp. | Comp. | Comp. | Comp. |
|---|---|---|---|---|---|
| | Ex. 1 | Ex. 2 | Ex. 3 | Ex. 4 | Ex. 5 |
| Binder resin composition | | | | | |
| (parts) | | | | | |
| ST/BA | 85/15 | 85/15 | 85/15 | 85/15 | 85/15 |
| DVB | 0.725 | — | — | 0.725 | — |
| MCM | 0.25 | — | — | 0.25 | — |
| Colorant (parts) | | | | | |
| PY180 | 6 | — | — | 6 | — |
| PHCB | — | 5 | 5 | — | 5 |
| Charge control resin (parts) | | | | | |
| CCR-2 | 6 | — | — | 6 | — |
| CCA | — | 2.5 | 2.5 | — | 2.5 |
| Parting agent (parts) | | | | | |
| Paraffin wax | — | 25 | 25 | — | 25 |
| DPEHM | 10 | — | — | 10 | — |
| Ellipse-shaping treatment | Not | Not | Not | Conducted | Not |
| | conducted | conducted | conducted | | conducted |
| Shell | Having | None | None | Having | None |
| MMA | 2 | — | — | 2 | — |
| Washing with methanol | Not | Not | Not | Not | Conducted |
| | conducted | conducted | conducted | conducted | |
| Volume average particle | 6.4 | — | — | 6.5 | — |
| diameter (μm) | | | | | |
| Particle diameter | 1.23 | 1.30 | 1.38 | 1.25 | 1.28 |
| distribution | | | | | |
| Weight average particle | — | 8.2 | 6.9 | — | 8.1 |
| diameter (μm) | | | | | |
| External additive | | | | | |
| Fine silica particles (12 nm) | 0.5 | — | — | 0.5 | — |
| Fine silica particles (40 nm) | 2.0 | — | — | 2.0 | — |
| Silica-coated alumina | 0.5 | — | — | 0.5 | — |
| Hydrophobic silica | — | 0.7 | 0.7 | — | 0.7 |
| Production process | Polymeri- | Polymeri- | Pulveri- | Polymeri- | Polymeri- |
| | zation | zation | zation | zation | zation |
| | process | process | process | process | process |

(Note)
ST = styrene, BA = n-butyl acrylate, DVB = divinylbenzene, PB15:3 = C.I. Pigment Blue 15:3, PY180 = C.I. Pigment Yellow 180, PR122 = C.I. Pigment Red 122, CB = carbon black, CCR-1 = the charge control resin 1 prepared in Preparation Example 1, DPEHM = dipentaerythritol hexamyristate, MMA = methyl methacrylate, MCM = polymethacrylic ester macromonomer, PHCB = Phthalocyanine Blue, CCR-2 = charge control resin (product of Fujikura Kasei Co., Ltd., trade name “FCA626N”), CCA = charge control agent (chromium di-t-butyl salicylate compound).

TABLE 3

| | Example | | | | Comparative Example | | | | |
|---|---|---|---|---|---|---|---|---|---|
| | 1 | 2 | 3 | 4 | 1 | 2 | 3 | 4 | 5 |
| (Physical property test) | | | | | | | | | |
| Work function (eV) | 5.90 | 6.00 | 6.10 | 5.90 | 5.52 | 5.58 | 5.60 | 5.80 | 5.65 |
| Gradient (normalized | 27.5 | 23.0 | 32.0 | 22.0 | 10.5 | 11.5 | 12.4 | 11.0 | 18.0 |
| photoelectron yield/excitation | | | | | | | | | |
| energy (1/eV) | | | | | | | | | |
| Extraction quantity with | 3.8 | 2.8 | 2.6 | 2.7 | 4.8 | 6.8 | 6.2 | 5.1 | 3.7 |
| methanol (%) | | | | | | | | | |
| Average circularity | 0.962 | 0.960 | 0.958 | 0.967 | 0.982 | 0.978 | 0.938 | 0.960 | 0.978 |
| Absolute value of charge level | 95 | 90 | 91 | 88 | 48 | 80 | 85 | 52 | 39 |
| \|Q\| (μC/g) | | | | | | | | | |
| (Printing test) | | | | | | | | | |
| Fixing temperature (° C.) | 160 | 160 | 160 | 160 | 160 | 170 | 170 | 160 | 170 |
| Offset temperature (° C.) | 210 | 210 | 210 | 210 | 200 | 210 | 200 | 200 | 210 |
| N/N initial printing density | 1.34 | 1.38 | 1.32 | 1.39 | 1.22 | 1.10 | 1.11 | 1.22 | 1.15 |
| H/H initial printing density | 1.54 | 1.48 | 1.51 | 1.46 | 1.45 | 1.37 | 1.40 | 1.40 | 1.41 |
| Durability | 10,000 | 10,000 | 10,000 | 10,000 | 7,500 | 6,000 | 9,000 | 8,500 | 6,000 |
| Cleaning ability | 10,000 | 10,000 | 10,000 | 10,000 | 8,500 | 8,000 | 9,500 | 9,000 | 9,000 |
| Stripe soiling, black spots | 10,000 | 10,000 | 10,000 | 10,000 | 8,000 | 7,000 | 10,000 | 9,000 | 7,000 |

### INDUSTRIAL APPLICABILITY

According to the present invention, there are provided toners, which are very easy to be cleaned off even when endurance printing is conducted and also excellent in environmental stability and printing durability. The toners produced by the present invention can be used as developers for copying machines, facsimiles, printers and the like by an electrophotographic system.

1. A developer for development of electrostatic images, comprising colored particles containing a binder resin, a colorant and a parting agent, and an external additive, wherein the developer has the following properties:
(a) a work function is at least 5.70 eV,
(b) when excitation energy (eV) in the measurement of the work function is plotted on an axis of abscissa, and a normalized photoelectron yield represented by the 0.5th power of a photoelectron yield per unit photon is plotted on an axis of ordinate, a gradient of the normalized photoelectron yield to the excitation energy is at least 15/eV, and
(c) an extraction quantity with methanol is 5.0% by weight or less.

2. The developer for development of electrostatic images according to claim 1, wherein the average circularity of the colored particles is 0.940 to 0.980.

3. The developer for development of electrostatic images according to claim 1, wherein the volume average particle diameter of the colored particles is 3 to 15 μm.

4. The developer for development of electrostatic images according to claim 1, wherein a ratio of the volume average particle diameter of the colored particles to the number average particle diameter thereof is 1.0 to 1.3.

5. The developer for development of electrostatic images according to claim 1, wherein the colored particles are colored polymer particles obtained by polymerizing a polymerizable monomer composition containing a polymerizable monomer, the colorant and the parting agent in an aqueous medium.

6. The developer for development of electrostatic images according to claim 1, wherein the colored particles are colored particles of a core-shell structure.

7. The developer for development of electrostatic images according to claim 6, wherein the colored particles of the core-shell structure are colored polymer particles of a core-shell structure, which are obtained by using the colored polymer particles obtained by polymerizing the polymerizable monomer composition containing the polymerizable monomer, the colorant and the parting agent in the aqueous medium as core particles and polymerizing a polymerizable monomer for shell in the presence of the core particles to form a polymer layer on each surface of the core particles.

8. The developer for development of electrostatic images according to claim 1, wherein the parting agent is an esterified product of a polyhydric alcohol and a carboxylic acid.

9. The developer for development of electrostatic images according to claim 1, wherein the parting agent is contained in a proportion of 1 to 20 parts by weight per 100 parts by weight of the polymer component making up the colored polymer particles.

10. The developer for development of electrostatic images according to claim 1, wherein the absolute value |Q| of a charge level of the developer is 50 to 120 μC/g.

11. The developer for development of electrostatic images according to claim 1, wherein the external additive comprises fine silica particles (A), the number average particle diameter of primary particles of which is 5 to 20 nm, or spherical fine silica particles (B) having a volume average particle diameter of 0.1 to 0.5 μm and a spheroidicity of 1.0 to 1.3, or a mixture thereof.

12. The developer for development of electrostatic images according to claim 11, wherein the fine silica particles (A) are contained in a proportion of 0.1 to 2 parts by weight per 100 parts by weight of the colored particles.

13. The developer for development of electrostatic images according to claim 11, wherein the spherical fine silica particles (B) are contained in a proportion of 0.5 to 2.5 parts by weight per 100 parts by weight of the colored particles.

14. The developer for development of electrostatic images according to claim 11, wherein the external additive further comprises fine silica particles (C), the number average particle diameter of primary particles of which is greater than 20 nm, but not greater than 100 nm,

15. The developer for development of electrostatic images according to claim 14, wherein the fine silica particles (C) are contained in a proportion of 0.1 to 2 parts by weight per 100 parts by weight of the colored particles.

16. A process for producing a developer for electrostatic image development, comprising the following Steps 1 to 4:
(1) Step 1 of dispersing a polymerizable monomer composition containing a polymerizable monomer, a colorant and a parting agent in an aqueous medium by high shear stirring to form droplets of the polymerizable monomer composition;
(2) Step 2 of raising the temperature of the aqueous medium containing the droplets to a polymerization temperature in the presence of a polymerization initiator to conduct polymerization of the polymerizable monomer composition;
(3) Purification Step 3 of separating colored polymer particles formed after the polymerization from the aqueous medium containing the colored polymer particles by filtration, washing the colored polymer particles with water to purify them, and at this time additionally conducting washing with an organic solvent that does not dissolve the colored polymer particles; and
(4) Step 4 of adding an external additive to colored polymer particles obtained by drying,
wherein the developer has properties that (a) a work function is at least 5.70 eV, (b) when excitation energy (eV) in the measurement of the work function is plotted on an axis of abscissa, and a normalized photoelectron yield represented by the 0.5th power of a photoelectron yield per unit photon is plotted on an axis of ordinate, a gradient of the normalized photoelectron yield to the excitation energy is at least 15/eV, and (c) an extraction quantity with methanol is 5.0% by weight or less.

17. The production process according to claim 16, wherein the organic solvent is an alcohol having 1 to 5 carbon atoms.

18. The production process according to claim 16, wherein the Step 2 includes a secondary process composed of the following Steps 2-1 to 2-3:
(I) Step 2-1 of raising the temperature of the aqueous medium containing the droplets to a polymerization temperature in the presence of a polymerization initiator to initiate polymerization of the polymerizable monomer composition;
(II) Step 2-2 of lowering the temperature of the aqueous medium to a temperature lower than the polymerization temperature while the conversion of the polymerizable monomer into a polymer falls within a range of 25 to 95%, and conducting high shear stirring again; and
(III) Step 2-3 of raising the temperature of the aqueous medium to the polymerization temperature again to continue the polymerization until the conversion of the polymerizable monomer into the polymer reaches at least 98%.

19. The production process according to claim 18, which provides colored polymer particles having an average circularity of 0.940 to 0.980.

20. The production process according to claim 16, which comprises further arranging, after the Step 2, Step 2B of pouring a polymerizable monomer for shell into the aqueous medium containing the colored polymer particles formed and polymerizing the polymerizable monomer for shell to form a polymer layer on each surface of the colored polymer particles.
